(19) United States
(12) Patent Application Publication
(10) Pub. No.: US 2003/0150314 A1
(43) Pub. Date: Aug. 14, 2003

(54) Multi-function combined processing machine for carpentry

(76) Inventor: Cai Bai He, N. Miami Beach, FL (US)

Correspondence Address: CAI BAI HE, 1050 NE 169 Terrace, N. Miami Beach, FL, 33162, US

(21) Appl. No.: 10/306,090

(22) Filed: Nov. 27, 2002

(30) Foreign Application Priority Data
Feb. 8, 2002 (CN) 02225705.5

(51) Int. Cl. B26D 5/08

(52) U.S. Cl. 83/581

(57) ABSTRACT

This new and practical model of machine is a kind of multi-function and combined processing Machine for Carpentry. On the stock of this machine are installed two or more than two types of processing tools for carpentry. The standing pillar of the stock is connected with one end of the function-changing string, while the other end of the function-changing string is connected with the function-changing shift fork. Between the function-changing shift fork and the outer shell of the function-changing gearbox are installed reset springs. The function-changing gears can be installed in the main axle of the electric machine in a moving way, and the function-changing shift fork is inserted into the fork groove of the function-changing gears. By this way, the function-changing shift fork can push the function-changing gear to slide along the main axle of the electric machine and thereby link up with the transmission gears of different types of processing tools for carpentry. By using only one stock and one electric machine, this new and practical model of machine can power many kinds of processing machines for carpentry. With its well-knit structure, this machine is very convenient to be used.

### FIELD OF INVENTION

This new and practical model of machine is a kind of multi-function and combined processing Machine for Carpentry.

### BACKGROUND OF THE INVENTION

The processing machinery is commonly used in such carpentry as indoor decoration, woodwork processing and furniture making. For example, carpenters will use stock electric saw to cut wood, use stock electric planer tool to process the surface of wood, and also they will use stock electric drill to bore a hole in wood. As a result, carpenters have to use many kinds of processing machines in the course of their work. In view of the fact that the work of carpenters is characterized by frequent mobility, using too many processing machines will make it quite inconvenient for carpenters to shift their work from one place to another.

### SUMMARY OF THE INVENTION

This new and practical model of machine is aimed at providing a kind of multi-function and combined processing machinery for carpentry. This machine, by virtue of using only one stock and one electric machine to power various kinds of processing tool for carpentry, proves to be a well-knit and easy-to-use instrument.

The main technical plan of this new and practical model of machine is as follows: on the stock of this multi-function and combined processing machine for carpenters are installed two or more than two types of processing tools for carpentry; the standing pillar of the stock is connected with one end of the function-changing string, while the other end of the function-changing string is connected with the function-changing shift fork. Between the function-changing shift fork and the outer shell of the function-changing gearbox is installed reset springs. The function-changing gears can be installed in the main axle of the electric machine in a moving way, and the function-changing shift fork is inserted into the fork groove of the function-changing gears. By this way, the function-changing shift fork can push the function-changing gear to slide along the main axle of the electric machine and thereby link up with the transmission gears of different types of processing tools for carpentry.

This new and practical model of machine will employ moving rotary sleeves. By virtue of the combined functions of the standing pillar of the stock, rotary sleeves, reset springs as well as the string, the function-changing shift fork can push the function-changing gear to slide along the main axle of the electric machine and thereby link up with the transmission gears of different types of processing tools for carpentry. Through this method, this multi-function and combined processing machinery for carpentry can use only one stock and one electric machine to power various kinds of processing tool for carpentry. With its well-knit structure, this machine is very convenient to be used and it can also satisfy different kinds of needs.

### BRIEF DESCRIPTION OF THE DRAWINGS

FIG. 1 is a view of this new and practical model of machine when it is used as electric saw.

FIG. 2 is the picture of the transmission structure illustrating the working state of FIG. 1.

FIG. 2A is the enlarged picture of the structure of both function-changing shift fork and function-changing gears.

FIG. 3 is the state picture of this new and practical model of machine when it is used as electric planer tool.

FIG. 4 is the picture of the transmission structure illustrating the working state of FIG. 3.

FIG. 5 is the structure picture of the electric planer tool installation.

FIG. 6 is the state picture of this new and practical model of machine when it is used as electric drill.

FIG. 7 is the picture of the transmission structure illustrating the working state of FIG. 6.

### DETAILED DESCRIPTION OF THE INVENTION

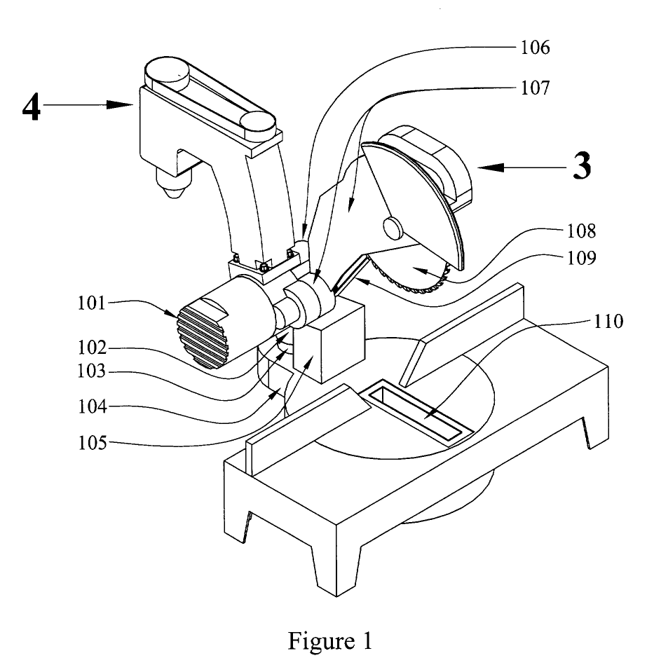

Just as FIGS. 1, 2 and 3 illustrate, in this case, on the stock 104 are installed the processing tools of carpentry, namely: electric planer tool 2, electric saw 3 and electric drill 4. Within the structure of this machine, electric machine 101 is connected with function-changing gear box 106, rotary sleeve 102 is fixed under the function-changing gearbox and is connected with the function-changing gearbox. The standing pillar of the stock 103 is linked with one end of the function-changing string 207, the other end of the function-changing string 207 is connected with the function-changing shift fork 201, and between the function-changing shift fork 201 and the outer shell of the function-changing gear box 106 is installed reset springs 206. Function-Changing gear 202 can be installed on the main axle of the electric machine 203 in a moving way, the function-changing shift fork 201 is inserted into the fork groove 210 of the function-changing gears 202 so that it can push the function-changing gear 202 to slide along the main axle of the electric machine 203 and thereby link up with the transmission gears of different types of processing tools for carpentry. Transmission axle of electric saw 209, transmission axle of electric planer tool 402 and transmission axle of electric drill 704 run parallel to the main axle of the electric machine 203, on the transmission axle of electric saw 209 was installed the transmission gear of electric saw 205 which can coordinate with the function-changing gear 202 through the transmission gear 204. In addition, transmission axle of electric saw 209 is also connected with the transmission installation of electric saw. On the transmission axle of electric planer tool 402 is installed the transmission gear of electric planer tool 401 which can match with the function-changing gear 202. Also, the transmission axle of electric planer tool 402 is joined with the transmission installation of electric planer tool, and on the transmission axle of electric drill 704 is fixed the transmission gear of electric drill 701 which can match with the function-changing gear 202. Besides, the transmission axle of electric drill 704 is also connected with the transmission installation of the electric drill.

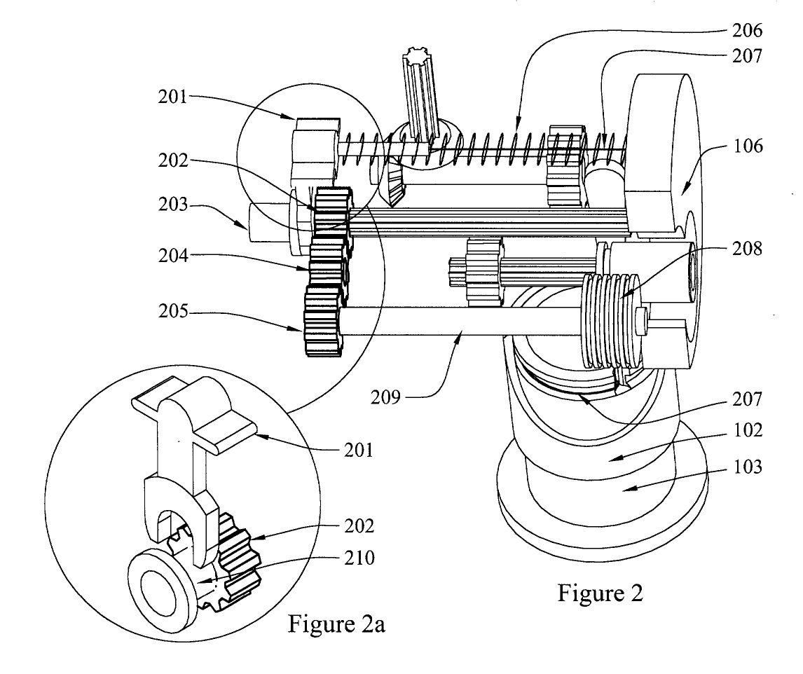

In the case that this new and practical model of machine will be used to saw wood, just as the FIGS. 1 and 2 illustrate, if only the electric saw blade 108 is set just against the groove of the stock 110, the reset spring 206 will be in the status of complete release. Then, the function-changing shift fork 201 will push the function-changing gear 202 to the electric saw transmission gear 204, and the electric machine 101 will power the transmission gear of electric saw 205 through the main axle of the electric machine 203, the function-changing gear 202 and the transmission gear 204, and the transmission axle of electric saw 209 will also transfer the power to the electric saw through the transmission belt roller of electric saw 208 and the transmission belt of electric saw 109. By this way, this new and practical model of machine will realize the function of ordinary stock electric saw.

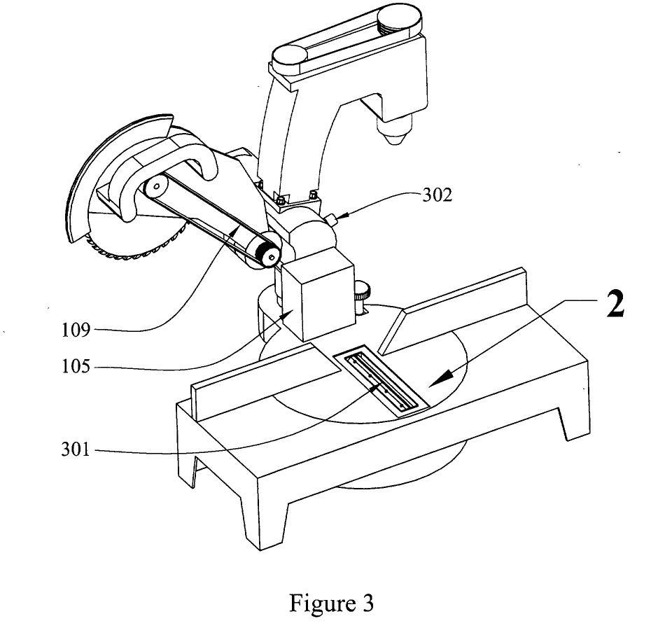

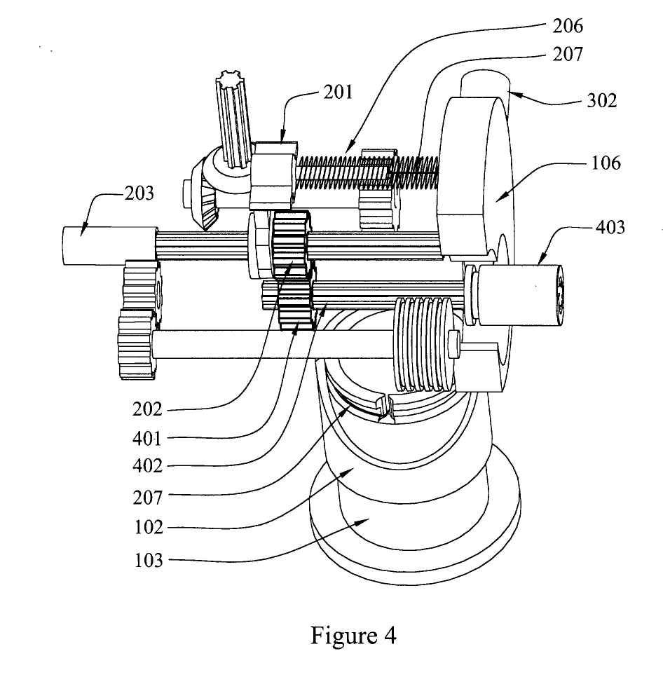

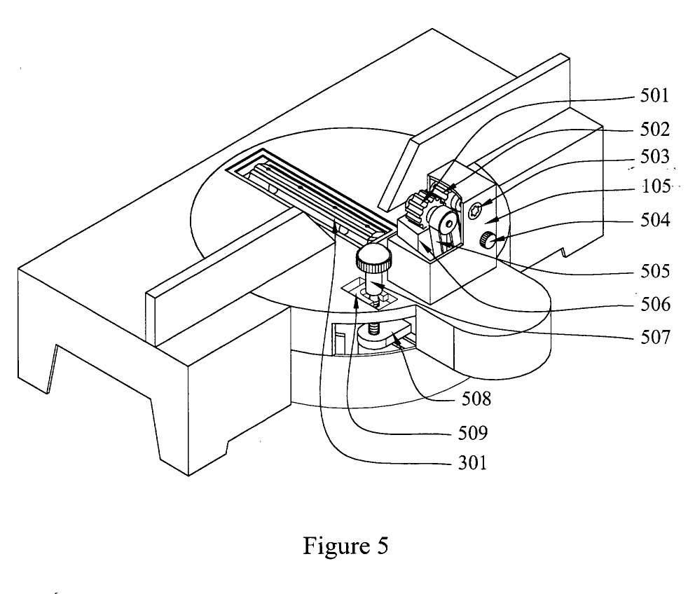

In the case that this new and practical model of machine will be used to plane wood, just as the FIG. 3, 4 and 5 illustrate, if only the electric saw is rotated by 90 degree in clockwise direction so that the function-changing gear box 106 is set just against the transmission gear box of electric planer tool 105, the rotary sleeve 102 will rotate, as a result of which, the function-changing string 207 will draw the function-changing shift fork 201 and in turn push the function-changing gear 202 to slide along the main axle of the electric machine 203; through this way, the function-changing gear 202 will match with the transmission gear of electric planer tool 401 and then make the transmission axle of electric planer tool 402 move. Loosen the forcing screw of electric planer tool 504, pull the lifting and anchorage handle of electric planer tool 507 in order to lift the hobbing cutter of electric planer tool which connects with the main slide arm of electric planer tool 506, then tighten the forcing screw of electric planer tool 504, push the anchorage locking chip of electric planer tool 509 to the location of the lifting and anchorage handle of electric planer tool 507, and finally tighten the lifting and anchorage handle of electric planer tool 507. Then, turn around the powered clutch handle of electric planer tool 302 so that the transmission clutch sleeve of electric planer tool 403 can be connected with the pattern part axle of electric planer tool 503, which causes the gear of pattern part axle of electric planer tool 502 to turn around, the gear of pattern part axle of electric planer tool 502 will make the belt roller of electric planer tool 501 turn around, and the belt roller of electric planer tool 501 will in turn make the hobbing cutter of electric planer tool 301 work through the transmission belt of electric planer tool 505. By this way, this new and practical model of machine will realize the function of ordinary electric planer tool.

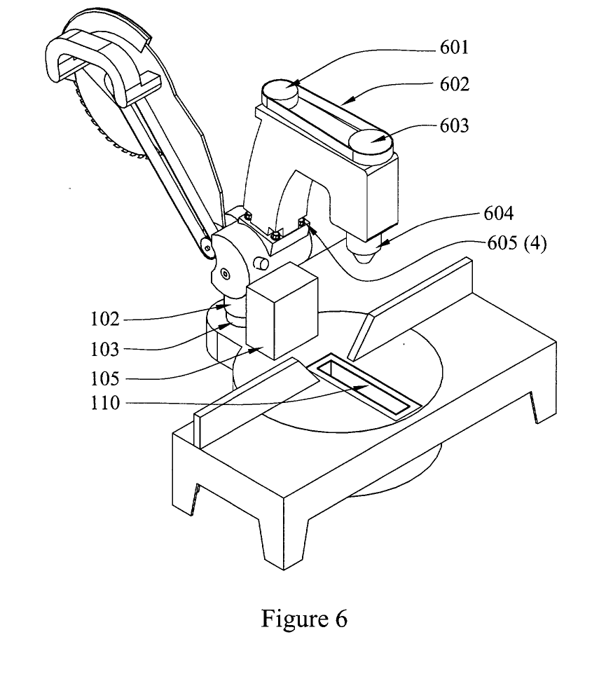

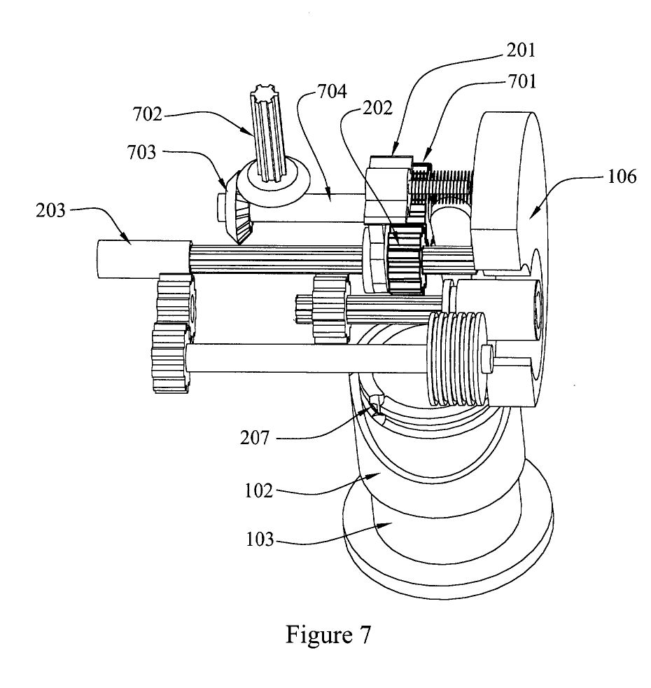

In the case that this new and practical model of machine will be used to bore a hole in wood, just as the FIG. 6 and 7 illustrate, if only the electric drill 4 is turned around so that the grip holder of electric drill 604 is set just against the groove of the stock 110, the rotary sleeve 102 will rotate, as a result of which, the function-changing string 207 will draw the function-changing shift fork 201 and in turn push the function-changing gear 202 to slide along the main axle of the electric machine 203; through this way, the function-changing gear 202 will match with the transmission gear of electric drill 701 and then make the transmission axle of electric drill 704 turn around. At that time, the power will be transferred to the grip holder of electric drill 604 through the transmission bevel gear of electric drill 703, transmission kingbolt of electric drill 702, transmission belt roller of electric drill 601, transmission belt of electric drill 602 and the belt roller of electric drill 603. By this way, this new and practical model of machine will realize the function of ordinary electric drill.

I claim:

1. This is a kind of multi-function and combined processing machine for carpentry. The Characteristics of this machine are as follows: on the stock (104) of this machine are installed two or more than two types of processing tools for carpentry. The standing pillar (103) of the stock is connected with one end of the function-changing string (207), while the other end of the function-changing string (207) is connected with the function-changing shift fork (201). Between the function-changing shift fork and the outer shell of the function-changing gearbox are installed reset springs (206). The function-changing gears (202) can be installed in the main axle of the electric machine (203) in a moving way, and the function-changing shift fork (201) is inserted into the fork groove (210) of the function-changing gears (202). By this way, the function-changing shift fork can push the function-changing gear (202) to slide along the main axle of the electric machine (203) and thereby link up with the transmission gears of different types of processing tools for carpentry.

2. The characteristics of the multi-function and combined processing machine for carpentry described in the first item of the claims are as follows: on the stock (104) of this machine are installed electric planer tool (2), electric saw (3) and electric drill (4). Transmission axle of electric planer tool (402), transmission axle of electric saw (209), and transmission axle of electric drill (704) run parallel to the main axle of the electric machine (203), on the transmission axle of electric saw (209) was installed the transmission gear of electric saw (205) which can coordinate with the function-changing gear (202) through the transmission gear (204). In addition, transmission axle of electric saw (209) is also connected with the transmission installation of electric saw:

3. The characteristics of the multi-function and combined processing machine for carpentry described in the first item of the claims are as follows: on the stock (104) of this machine are installed electric planer tool (2), on the transmission axle of electric planer tool (402) is installed the transmission gear of electric planer tool (401) which can match with the function-changing gear (202), on the transmission axle of electric planer tool (402) is installed the transmission clutch sleeve of electric planer tool (403), on the stock (104) of this machine is also installed the transmission gear box of electric planer tool (105), within the transmission gear box of electric planer tool (105) are installed the gear of pattern part axle of electric planer tool (502) which connects with the pattern part axle of electric planer tool (503), within the transmission gear box of electric planer tool (105) is fixed the main slide arm of electric planer tool (506), on the main slide arm of electric planer tool (506) is installed the belt roller of electric planer tool (501) which can slide up and down the main slide arm of electric planer tool (506), the belt roller (501) is connected with the transmission installation of electric planer tool through the transmission belt of electric planer tool (505).

4. The characteristics of the multi-function and combined processing machine for carpentry described in the first item of the claims are as follows: on the stock (104) of this machine are installed electric drill (4), on the transmission axle of electric drill (704) is fixed the transmission gear of electric drill (701) which can match with the function-changing gear (202), and the transmission kingbolt of electric drill (702) is also connected with the transmission installation of the electric drill.
